(19) United States
(12) Patent Application Publication
(10) Pub. No.: US 2011/0259164 A1
(43) Pub. Date: Oct. 27, 2011

(54) SHEAR WITH VARIABLE STROKE CUTTING

(76) Inventors: Michael Trevor Clark, Yorkshire (GB); Nick Champion, Yorkshire (GB); David Stone Cliffe, Yorkshire (GB)

(21) Appl. No.: 13/128,743

(22) PCT Filed: Nov. 12, 2009
(86) PCT No.: PCT/GB2009/051524

§ 371 Date: Jul. 11, 2011

(30) Foreign Application Priority Data
Nov. 14, 2008 (GB) 0820875.3

(51) Int. Cl. B23D 15/14; B23D 36/00

(52) U.S. Cl. 83/13; 83/76.1

(57) ABSTRACT

A rolling cut metal shearing apparatus is described in which the starting and, or end position of a shear blade is varied according to the width, position and thickness of material to be cut, thereby optimising the stroke of the blade for the material dimensions. This provides for shorter cutting times, reduced volumes of hydraulic fluid and increased throughput.

### CROSS-REFERENCE TO RELATED APPLICATIONS

This application is a U.S. National Stage Application of International Application No. PCT/GB2009/051524 filed Nov. 12, 2009, which designates the United States of America, and claims priority to GB Application No. 0820875.3 filed Nov. 14, 2008. The contents of which are hereby incorporated by reference in their entirety.

### TECHNICAL FIELD

The invention relates to the general field of shearing and in particular to the shearing of metal plates and strips.

### BACKGROUND

The use of hydraulically operated shearing machines to cut sheet metal is well known. For example, GB 2405118 A describes a hydraulically actuated rolling blade shear which achieves a rocking type shearing action by using a curved shear blade and two separately controlled hydraulic cylinders.

Applicants co-pending patent application number EP 0725358.8 describes an arrangement which addresses the wide range of demands made by a system required to provide the actuating force necessary to deal with thick and, or wide material but which can also achieve the cutting cycle times and reset-times typically required when cutting thin and, or narrow material.

A hydraulic actuating mechanism is described in which at least one hydraulic cylinder can be switched in and out of operation mode, independently of at least one other hydraulic cylinder of the mechanism. For example, the mechanism may comprise at least one cylinder having a relatively small effective area, and at least one cylinder having a relatively large effective area, the latter being switchable in and out of operation mode.

Typically, a control system determines whether one or more cylinders is in operation mode with regard to the width and thickness of material being cut.

Applicant's co-pending applicaton GB 0819362.5 describes apparatus and a method in which consecutive cuts by the rolling blade are performed in the opposite direction in order to reduce further the volume of hydraulic fluid required and the cutting cycle time.

### SUMMARY

These advances in the art notwithstanding, the desire to reduce further the cutting cycle times of shearing machines along with the volume of hydraulic oil which needs to be moved during the cycle remains.

According to an embodiment, an apparatus for shearing metal may comprise upper and lower blades arranged to cooperate and provide a shearing function by a rolling action of the upper blade from a first starting position in a first direction to a first end position; a controller, arranged to control motor means and therby control motion of the upper blade and wherein the controller is arranged to receive data indicating dimensions and position of material to be cut, and vary the first starting position of the upper blade responsive to said data.

According to a further embodiment, the controller can be further arranged to vary the first end position, responsive to said data. According to a further embodiment, the motor means may comprise at least one hydraulic cylinder, the controller being arranged to determine the stroke of one or more cylinders by operation of one or more valves. According to a further embodiment, the controller can be further arranged to effect a rolling action of the upper blade from a second starting position in a second direction and to vary said second starting position responsive to the data.

### BRIEF DESCRIPTION OF THE DRAWINGS

The invention will now be described by non-limiting example, with reference to the appended drawings in which:

FIG. 1 illustrates a typicall conventional rolling cut shear;

FIGS. 2 and 3 illustrate the rolling action of the device of FIG. 1;

FIG. 4 illustrates the action of a rolling cut shear according to various embodiments and

FIGS. 5 and 6 illustrate how the starting position for the second cut is revised.

### DETAILED DESCRIPTION

According to various embodiments, such a further advance in the art is provided by a shearing apparatus having upper and lower blades arranged to cooperate and provide a shearing function by a rolling action of the upper blade from a first starting position in a first direction to a first end position;

a controller, arranged to control motor means and therby control motion of the upper blade and being
characterised in that the controller is arranged to receive data indicating dimensions and position of material to be cut, and vary the first starting position of the upper blade responsive to said data.

Preferrably, the controller is further arranged to vary the first end position, responsive to said data.

In another embodiment, the motor means comprises at least one hydraulic cylinder, the controller being arranged to determine the stroke of one or more cylinders by operation of one or more valves.

In yet another embodiment, the controller is further arranged to effect a rolling action of the upper blade from a second starting position in a second direction and to vary said second starting position responsive to the data.

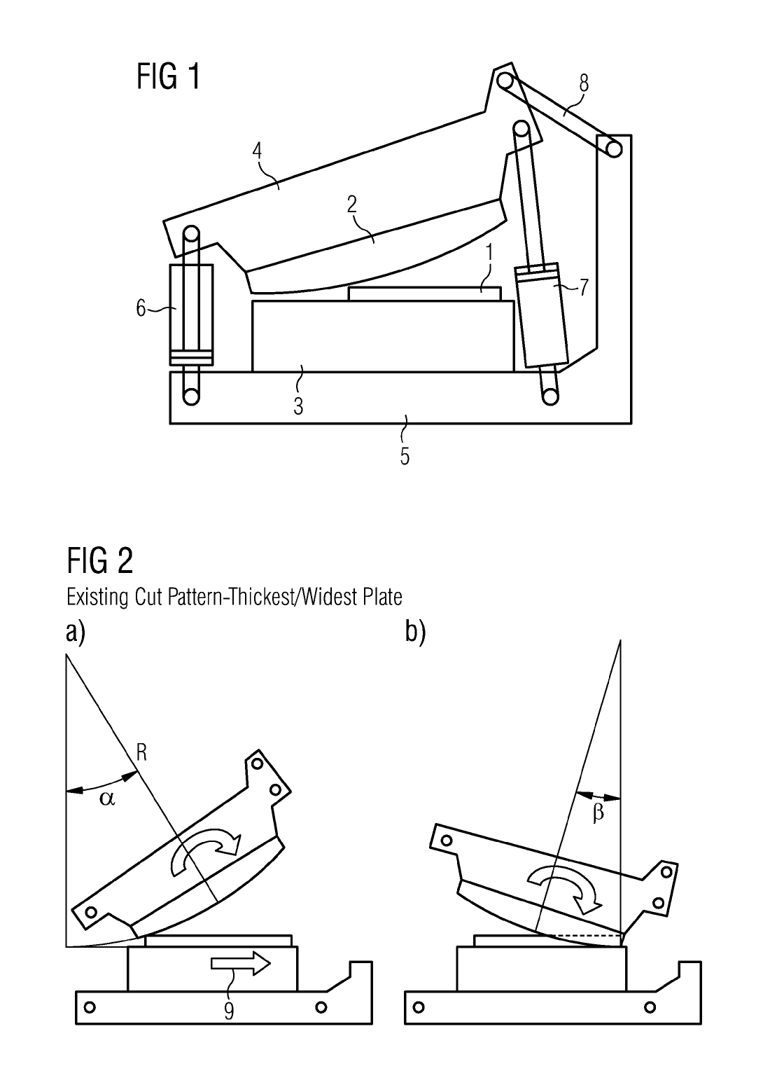

Referring to FIG. 1, in a conventional shearing apparatus, the material to be cut 1 is positioned between an upper curved shear blade 2 and a lower straight shear blade 3. The upper curved shear blade 2 is attached to an upper support beam 4 and the lower straight shear blade 3 is attached to a lower support beam 5. Two hydraulic cylinders 6 and 7 of a hydraulic actuating-mechanism are connected between the upper support beam 4 and the lower support beam 5. Each of the hydraulic cylinders 6 and 7 engages the upper support beam 4 in one engaging-area, hydraulic cylinder 6 in the engaging area on the left end of upper support beam 4, and hydraulic cylinder 7 in the engaging area on the right end of upper support beam 4. By controlling the stroke of hydraulic cylinders 6 and 7 separately but in a synchronized manner the upper shear blade 2 can be caused to execute a rocking type shearing action.

In such apparatus of the prior art, the starting position of the upper blade 2, prior to commencement of the rolling cut, does not vary with the width or thickness of the material 1. In fact, the starting position is based on an assumption that material of maximum width and thickness is being cut.

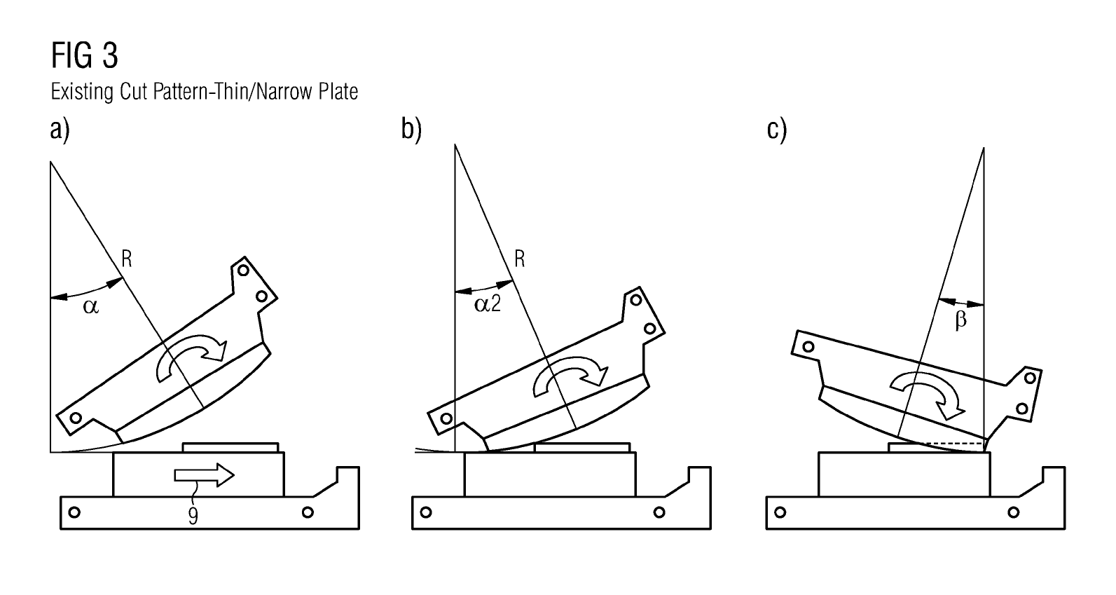

Referring to FIG. 2, where the arrow 9 indicates the direction of cut, the cutting angle, α, of the upper blade 2 at the beginning of a cut (FIG. 2(a)) where maximum thickness and width are assumed is given by:

α=0.5*Max_width/R+acos(1−Max thickness/R)
αin radians
Max_width=max width of plate to cut
Max_thickness=maximum thickness of plate to cut
R=radius of curved top blade.

Referring to FIG. 3, it is clear that when the shear is cutting narrower and/or thinner plate then the movement between the start of the motion at angle α(FIG. 3(a)) and the actual start of cutting at angle α2 (FIG. 3(b)) represents unnecessary movement.

α2=0.5*width/R+acos(1−thickness/R)
width=actual width of plate being cut (<Max_width) thickness=actual thickness of plate being cut (<Max_thickness)

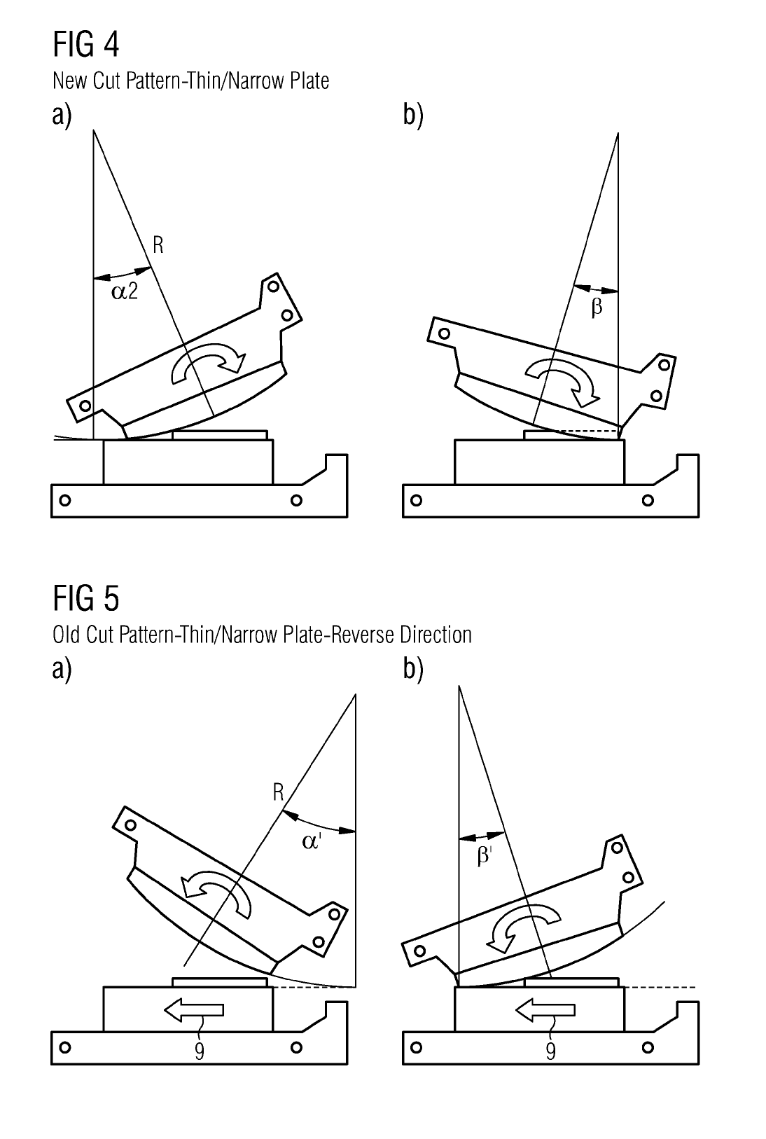

Referring to FIG. 4, according to various embodiments, the starting point for the cutting movement is adjusted according to the known thickness and width of the plate being sheared (FIG. 4(b)) so that instead of always starting the movement at angle α the rolling cut motion starts at angle α2. In FIGS. 2, 3 and 4 it is assumed that the plate is aligned against a datum edge so that angle β at the end of the cut (2(b), 3(c) and 4(b)) is always the same. However, clearly if the plate is not aligned against a datum then, so long as its location is known—e.g. from a sensor—then the controller can also change the position of the end point of the movement according to the actual angle β.

As noted previously, existing prior art systems already employ controllers that utilise width and thickness data (of the material to be cut) to make determinations such as how may cylinders to operate in order to provide the necessary cutting force. The provision of such a system which utilises such data to determine a starting position for the upper blade in order to minimise unnecessary movement of the blade before the material 1 is engaged, is within the abilities of a person skilled in the art in view of the present disclosure.

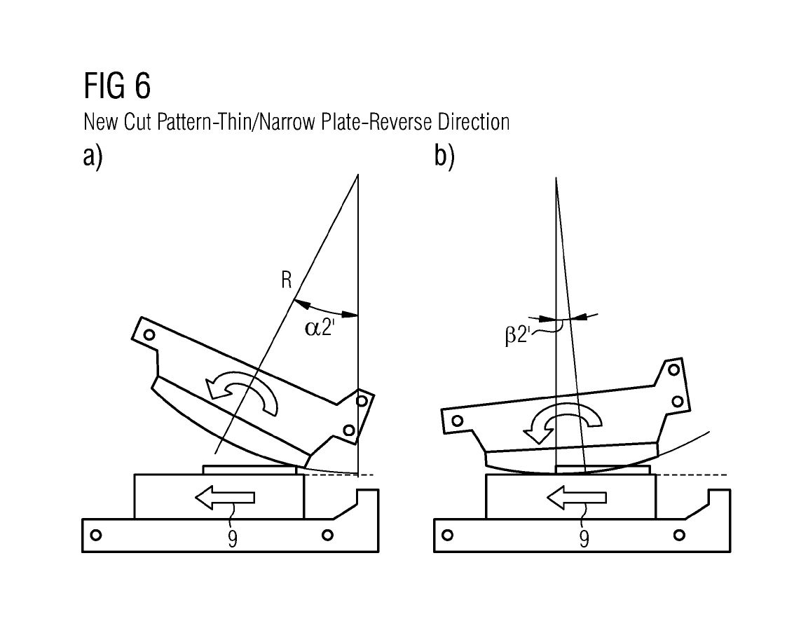

The various embodiments may be combined with that described in GB 0819362.5. In such a system, the starting and finishing positions of the blade for cuts in each direction are selected to minimise unnecessary movement of the blade prior to engagement of the material and after the end of the cut. FIGS. 5 and 6 illustrate how the starting position for the second cut α′ is revised to α2′ according to the width and thickness of the material being cut. The finishing position for the second cut is also variable: in practice this is likely to equate to the starting position for the first cut.

Moreover, while the invention has been described with reference to hydraulically operated systems, it is also applicable to other types of shear (e.g. crank driven) where the benefits of reduced cutting cycle time/increased throughput are still realised.

What is claimed is:

1. An apparatus for shearing metal comprising:
upper and lower blades arranged to cooperate and provide a shearing function by a rolling action of the upper blade from a first starting position in a first direction to a first end position; and
a controller, arranged to control motor means and thereby control motion of the upper blade;
wherein the controller is arranged to receive data indicating dimensions and position of material to be cut, and vary the first starting position of the upper blade responsive to said data.

2. The apparatus according to claim 1, wherein the controller is further arranged to vary the first end position, responsive to said data.

3. The apparatus according to claim 1, wherein the motor means comprises at least one hydraulic cylinder, the controller being arranged to determine the stroke of one or more cylinders by operation of one or more valves.

4. The apparatus according to claim 1, wherein the controller is further arranged to effect a rolling action of the upper blade from a second starting position in a second direction and to vary said second starting position responsive to the data.

5. The apparatus according to claim 1, wherein the upper blade is attached to an upper support beam and the lower blade is attached to a lower support beam.

6. The apparatus according to claim 5, wherein first and second hydraulic cylinders of a hydraulic actuating-mechanism are connected between the upper support beam and the lower support beam.

7. The apparatus according to claim 6, wherein the first hydraulic cylinder engages the upper support beam in the engaging area on the left end of upper support beam, and the second hydraulic cylinder in the engaging area on the right end of upper support beam.

8. The apparatus according to claim 6, wherein by controlling the stroke of the first and second hydraulic cylinders separately but in a synchronized manner the upper blade can be caused to execute a rocking type shearing action.

9. The apparatus according to claim 8, wherein the starting point for the cutting movement is adjusted according to a known thickness and width of a plate being sheared.

10. The apparatus according to claim 1, further comprising a location sensor for determining the position of the material to be cut, wherein the controller is further operable to change the position of the end point of the movement according to an actual angle β being dependent on said position.

11. A method for operating an apparatus for shearing metal with upper and lower blades arranged to cooperate and provide a shearing function by a rolling action of the upper blade from a first starting position in a first direction to a first end position;
the method comprising:
receiving data indicating dimensions and position of material to be cut, and
varying a first starting position of the upper blade responsive to said data.

12. The method according to claim 11, further comprising: varying the first end position responsive to said data.

13. The method according to claim 11, further comprising: determining the stroke of one or more cylinders to move said upper blade by operation of one or more valves.

14. The method according to claim 11, further comprising: effecting a rolling action of the upper blade from a second starting position in a second direction and varying said second starting position responsive to the data.

15. The method according to claim 11, wherein the first starting position is adjusted according to a known thickness and width of a plate being sheared.

16. The method according to claim 11, further comprising determining the position of the material to be cut, and changing the position of the end position according to an actual angle β being dependent on said position.
